(19) United States
(12) Patent Application Publication
(10) Pub. No.: US 2008/0246760 A1
(43) Pub. Date: Oct. 9, 2008

(54) METHOD AND APPARATUS FOR MAPPING TEXTURE ONTO 3-DIMENSIONAL OBJECT MODEL

(75) Inventors: Ji-won Jeong, Suwon-si (KR); Seong-hun Jeong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/954,729

(22) Filed: Dec. 12, 2007

(30) Foreign Application Priority Data
Apr. 5, 2007 (KR) 10-2007-0033779

(51) Int. Cl. G06T 17/00; G09G 5/00

(52) U.S. Cl. 345/420; 345/649

(57) ABSTRACT

Provided are a method and apparatus for mapping texture onto a 3-dimensional (3D) object model. The method includes converting object model data, in which at least one object is modeled, into object model data of a predetermined view point, generating raster graphics data expressing the texture of the object by data in pixel units based on vector graphics data expressing the texture of the object in a geometrical equation, and mapping the texture formed of the generated raster graphics data onto an object model expressed by the converted object model data. By using the method, the amount of resources and operations are low, and thus various effects can be realized which could not be realized due to a limit in processing speed. Accordingly, an appearance of reality of a 3D image can be remarkably improved.

### CROSS-REFERENCE TO RELATED PATENT APPLICATIONS

This application claims priority from Korean Patent Application No. 10-2007-0033779, filed on Apr. 5, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to mapping texture onto a 3-dimensional (3D) object model, and more particularly, to mapping 2-dimensional (2D) texture onto a 3D object model.

2. Description of the Related Art

Recently, demands for a 3D image display in various devices have increased as a processing capacity of a processor improves and a 3D engine develops. A 3D image display is requested not only in a high specification personal computer (PC), such as a workstation, but also in a device having a display, such as a television (TV), a portable media player (PMP), an MP3 player, or a mobile phone. Also, applications which require a 3D image display are expanding. Those applications cover a simulation system, a virtual reality system, games such as online games, console games, and mobile games, an avatar system, a user interface, an animation, and so on. A 3D engine is defined by a method or apparatus for automatically converting a 3D wire frame model into a 2D image.

A 3D model is formed by a combination of polygons, and when the texture of the 3D model is expressed by only using colors of the polygons, an appearance of reality of the 3D model deteriorates. Accordingly, various methods of mapping texture exist for improving the appearance of reality of the 3D model. Texture mapping is used to increase the appearance of reality of the 3D model by adding texture to the combination of the polygons. The texture is a graphic put on the surface of the polygons.

In order to improve the reality appearance of a 3D model in a 3D space, an animation effect is mostly used by using texture animation. In texture animation, a method of expressing an animation effect by sequentially changing several sheets of texture of the same size according to time, and a method of expressing an animation effect by mapping large sized texture onto a 3D model and then rotating or moving the mapped texture are mainly used. Also, the texture animation may use a method of rotating or moving a camera.

The texture animation provides an environment similar to the real world by not only providing a stereoscopic image by giving texture, light source effect, etc. to a 2D image but also by enabling a user to adjust a visual field. However, according to conventional texture mapping, texture can be mapped only on a pre-prepared image, and thus it is difficult to express a soft texture animation according to a situation. In a method of expressing an animation effect using texture, which is used the most, several sheets of texture are pre-prepared and sequentially changed according to a time or situation. With this method, however, smooth animation is difficult when the number of pre-prepared sheets of texture is small, and the entire processing speed decreases when texture is used until it is possible to express smooth animation because the entire size of texture increases and thus large resources are used. Also, using the method of expressing an animation effect by mapping large sized texture onto a 3D model and then rotating or moving the mapped texture, it is difficult to avoid monotony because only pre-set texture is continuously repeated, and so it is difficult to process a realistic 3D image.

Accordingly, the above methods are difficult to apply to a 3D image, because a large amount of resources and operations are required in order to express an appearance of reality in real time.

### SUMMARY OF THE INVENTION

The present invention provides a method and apparatus for generating texture in real time using vector graphics data and mapping the texture onto a 3D object model.

The present invention also provides a computer readable recording medium having recorded thereon a program for executing the method described above.

According to an aspect of the present invention, there is provided a method of mapping texture, including: converting object model data, in which at least one object is modeled, to object model data of a predetermined view point; generating raster graphics data expressing the texture of the object by data in pixel units, based on vector graphics data expressing the texture of the object in a geometrical equation; and mapping the texture formed of the generated raster graphics data onto an object model expressed by the converted object model data.

According to another aspect of the present invention, there is provided a computer readable recording medium having recorded thereon a program for executing the method described above.

According to another aspect of the present invention, there is provided an apparatus for mapping texture, including: a geometry converter which converts object model data, in which at least one object is modeled, to object model data from a predetermined view point; a raster graphics generator which generates raster graphics data expressing the texture of the object by data in pixel units, based on vector graphics data expressing the texture of the object in a geometrical equation; and a rasterizer which maps the texture formed of the generated raster graphics data onto an object model expressed by the converted object model data.

### BRIEF DESCRIPTION OF THE DRAWINGS

The above and other aspects of the present invention will become more apparent by describing in detail exemplary embodiments thereof with reference to the attached drawings, in which:

FIG. 1 is a block diagram of an apparatus for mapping texture onto a 3-dimensional (3D) object model according to an exemplary embodiment of the present invention;

FIG. 2 is a flowchart of a method of mapping texture onto a 3D object model according to an exemplary embodiment of the present invention; and

FIG. 3 is a flowchart of a method of generating texture performed in a raster graphics generator illustrated in FIG. 1, according to an exemplary embodiment of the present invention.

### DETAILED DESCRIPTION OF EXEMPLARY EMBODIMENTS

Hereinafter, the present invention will be described more fully with reference to the accompanying drawings, in which exemplary embodiments of the invention are shown.

The present invention relates to a 3-dimensional (3D) graphic pipeline. The 3D graphic pipeline is a process of generating a 2-dimensional (2D) image from geometrical data expressing an object or scene in a 3D space and outputting the 2D image to a screen.

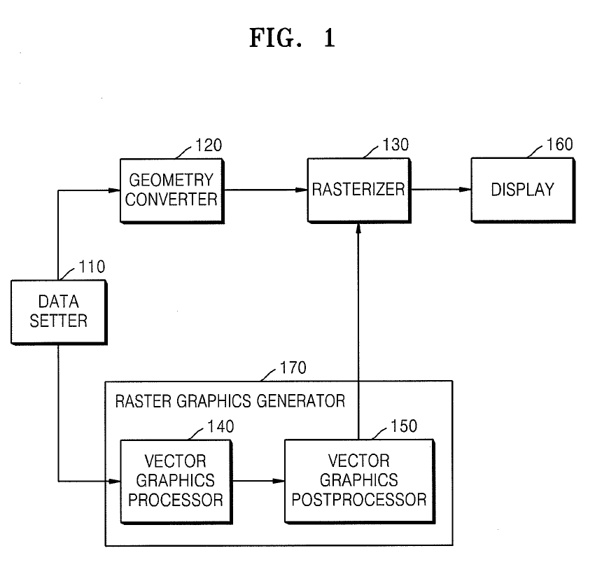

FIG. 1 is a block diagram of an apparatus for mapping texture onto a 3D object model according to an exemplary embodiment of the present invention.

Referring to FIG. 1, the apparatus includes a data setter 110, a geometry converter 120, a rasterizer 130, a raster graphics generator 170, and a display 160. The raster graphics generator 170 includes a vector graphics processor 140 and a vector graphics postprocessor 150.

Vector graphics uses geometrical base components, such as a point, a line, a curve, and a polygon based on a mathematical function, in order to express an image. The vector graphics renders an image which is expressed using a line and curve of a vector having color and location information. When the vector graphics is edited, a property of a line and curve showing a shape of graphics is adjusted, and thus the vector graphics is not affected by resolution. In other words, the vector graphics can be moved, the size of the vector graphics can be adjusted, and the shape and color of the vector graphics can be changed without changing the quality of the vector graphics, and also the vector graphics can be shown by an output device in various resolutions. For example, a straight line is expressed by coordinates of a function for drawing a straight line, and two end points, and a circle is expressed by coordinates of a function for drawing a circle, the center of the circle, and its radius. Here, mathematical functions are directly stored in a memory in a graphics command form, and thus the size of a graphics file is small.

In raster graphics, the values of pixels forming graphics objects are directly stored in a memory. Unlike the vector graphics in which images are stored in a memory as graphics commands denoting mathematical functions, the values of pixels corresponding to images are stored in a memory in the raster graphics. Accordingly, when the size of an image is enlarged, only the size of pixels forming the image increases, and thus the quality of the image deteriorates. In the vector graphics, the size of an image file increases in proportion to the complexity of the image on a screen, but in the raster graphics, the size of an image file is unrelated to the complexity of the image on a screen.

The data setter 110 classifies data according to the characteristics of the data, outputs 3D model data expressing an object or a scene in a 3D space to the geometry converter 120, and outputs vector graphics data, that is to be used as texture, to the vector graphics processor 140. The texture denotes a 2D image having the quality or feel of a material, and texture mapping puts the texture on the surface of a 3D object.

The geometry converter 120 receives the 3D model data from the data setter 110 and converts the received 3D model data to 3D model data in a direction that a camera is facing. Such a conversion not only includes basic geometrical conversions, such as movement, expansion, contraction, and rotation, but also includes special conversions, such as reflection, and shearing.

The rasterizer 130 receives the 3D model data converted in the geometry converter 120 and generates an image that is to be displayed on a screen by mapping the texture generated in the raster graphics generator 170 on the received 3D model data. The generated image may be formed in raster graphics.

The raster graphics generator 170 receives the vector graphics data from the data setter 110, generates texture from the received vector graphics data, and outputs the generated texture to the rasterizer 130.

The vector graphics processor 140 receives the vector graphics data from the data setter 110 and generates an image frame formed of raster graphics from the received vector graphics data.

The vector graphics postprocessor 150 receives the image frame generated in the vector graphics processor 140, and converts the received image frame to texture that can be mapped onto an object model expressed by the 3D model data which is transmitted from the geometry converter 120 to the rasterizer 130.

The display 160 receives the image generated in the rasterizer 130 and displays the object or scene in the 3D space on an actual screen using the received image. The display 160 may include a frame buffer (not shown).

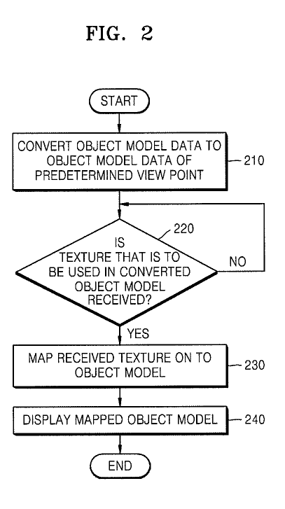

FIG. 2 is a flowchart of a method of mapping texture onto a 3D object model according to an exemplary embodiment of the present invention.

Referring to FIGS. 1 and 2, the method according to the current exemplary embodiment is formed of operations performed time sequentially in the apparatus illustrated in FIG. 1. Accordingly, the descriptions of the apparatus of FIG. 1 can also be applied to the method of the current exemplary embodiment where the description is omitted.

In operation 210, the apparatus for mapping texture onto a 3D object model converts 3D model data to 3D model data of a predetermined view point. Such a conversion not only includes basic geometrical conversions, such as movement, expansion, contraction, and rotation, but also includes special conversions, such as reflection, and shearing.

In operation 220, the apparatus determines whether the rasterizer 130 has received texture that is to be used on a 3D model expressed by the 3D model data converted in operation 210 from the vector graphics postprocessor 150. When the texture is not received, the rasterizer 130 stands by until the texture is received from the vector graphics postprocessor 150, and when the texture is received, operation 230 is performed.

In operation 230, the rasterizer 130 maps the texture received from the vector graphics postprocessor 150 onto the 3D model expressed by the 3D model data converted in the geometry converter 120.

In operation 240, the apparatus displays the 3D model, onto which the texture is mapped, on a screen.

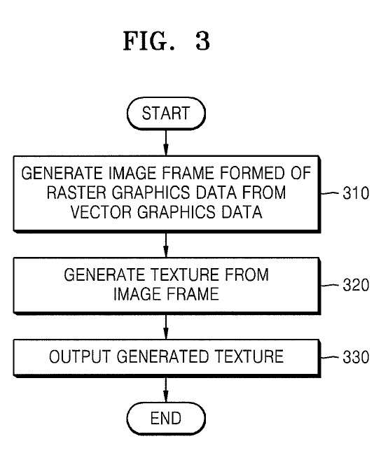

FIG. 3 is a flowchart of a method of generating texture performed in a raster graphics generator illustrated in FIG. 1. The method will be described with reference to FIGS. 1 and 3.

In operation 310, the vector graphics processor 140 generates an image frame formed of raster graphics data from vector graphics data received from the data setter 110.

In operation 320, the vector graphics postprocessor 150 generates texture that is to be mapped onto a 3D model from the image frame received from the vector graphics processor 140.

In operation 330, the vector graphics postprocessor 150 outputs the texture generated in operation 320 to the rasterizer 130.

The exemplary embodiments of the present invention can be written as computer programs and can be implemented in general-use digital computers that execute the programs using a computer readable recording medium. Also, data structures used in the exemplary embodiments of the present invention can be recorded on a computer readable recording medium via various means.

Examples of the computer readable recording medium include magnetic storage media (e.g., ROM, floppy disks, hard disks, etc.), optical recording media (e.g., CD-ROMs, or DVDs), etc.

According to the present invention, suitable texture can be generated and used in each frame without using a large amount of texture or operations while expressing a smooth animation effect, by generating dynamic texture using vector graphics data and using the generated dynamic texture as a texture source to give an animation effect in a 3D image. Also, a brilliant and realistic animation effect in a 3D image can be easily processed, and a high quality 3D image can be processed even in a small and light 3D engine. Moreover, a small amount of resources and operations are used, and thus the reality of a 3D image can be remarkably increased since various effects can be realized, which could not be realized conventionally due to a limit in processing speed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of mapping texture, comprising:
converting first object model data, in which at least one object is modeled, to second object model data of a predetermined view point;
generating raster graphics data expressing a texture of the object by data in pixel units, based on vector graphics data expressing the texture of the object in a mathematical function; and
mapping a texture formed of the generated raster graphics data onto an object model expressed by the second object model data.

2. The method of claim 1, wherein the converting of the first object model data and the generating of the raster graphics data are performed at a substantially same time.

3. The method of claim 2, wherein the generating of the raster graphics data comprises:
generating an image frame formed of the raster graphics data from an image frame formed of the vector graphics data; and
generating the texture formed of the generated raster graphics data from the generated image frame.

4. The method of claim 2, wherein the converting of the first object model data comprises moving the first object model data in parallel, enlarging the first object model data, reducing the first object model data, and rotating the object model data.

5. The method of claim 2, wherein the first object model data is 3D object model data, in which a 3D object is modeled.

6. The method of claim 2, further comprising outputting the object model to a screen.

7. The method of claim 1, wherein the generating of the raster graphics data comprises:
generating an image frame formed of the raster graphics data from an image frame formed of the vector graphics data; and
generating the texture formed of the generated raster graphics data from the generated image frame.

8. The method of claim 1, wherein the converting of the first object model data comprises moving the first object model data in parallel, enlarging the first object model data, reducing the first object model data, and rotating the first object model data.

9. The method of claim 1, wherein the first object model data is 3D object model data, in which a 3D object is modeled.

10. The method of claim 1, further comprising outputting the object model to a screen.

11. An apparatus for mapping texture, comprising:
a geometry converter which converts first object model data, in which at least one object is modeled, to second object model data of a predetermined view point;
a raster graphics generator which generates raster graphics data expressing a texture of the object by data in pixel units, based on vector graphics data expressing the texture of the object in a geometrical equation; and
a rasterizer which maps a texture formed of the generated raster graphics data onto an object model expressed by the second object model data.

12. (canceled)

13. The apparatus of claim 11 wherein the geometry converter converts the first object model data and the raster graphics generator generates raster graphics data at a substantially same time.

14. The apparatus of claim 13, wherein the raster graphics generator comprises:
a vector graphics processor which generates an image frame formed of the raster graphics data from an image frame formed of the vector graphics data; and
a vector graphics postprocessor which generates the texture formed of the generated raster graphics data from the generated image frame.

15. The apparatus of claim 13, wherein the converting of first object model data, in which the at least one object is modeled, performed by the geometry converter comprises moving the first object model data in parallel, enlarging the first object model data, reducing the first object model data, and rotating the first object model data.

16. The apparatus of claim 13, wherein the first object model data is 3-dimensional (3D) object model data in which a 3D object is modeled.

17. The apparatus of claim 13, further comprising a display which receives the object model from the rasterizer and outputs the received object model to a screen.

18. The apparatus of claim 11, wherein the raster graphics generator comprises:
a vector graphics processor which generates an image frame formed of the raster graphics data from an image frame formed of the vector graphics data; and
a vector graphics postprocessor which generates the texture formed of the generated raster graphics data from the generated image frame.

19. The apparatus of claim 11, wherein the converting of first object model data, in which the at least one object is modeled, by the geometry converter comprises moving the first object model data in parallel, enlarging the first object model data, reducing the first object model data, and rotating the first object model data.

20. The apparatus of claim 11, wherein the first object model data is 3-dimensional (3D) object model data in which a 3D object is modeled.

21. The apparatus of claim 11, further comprising a display which receives the object model from the rasterizer and outputs the received object model to a screen.

22. A computer readable recording medium having recorded thereon a program for executing the method of claim 1.

23-26. (canceled)
